(19) United States
(12) Patent Application Publication
(10) Pub. No.: US 2022/0343776 A1
(43) Pub. Date: Oct. 27, 2022

(54) Universal Computing Node in a Smart Self-Healing node Centric Blockchain Mesh Network

(71) Applicant: Michele Di Cosola, Bloomingdale, IL (US)

(72) Inventor: Michele Di Cosola, Bloomingdale, IL (US)

(21) Appl. No.: 17/855,757

(22) Filed: Jun. 30, 2022

Related U.S. Application Data
(63) Continuation-in-part of application No. 17/683,339, filed on Feb. 28, 2022.
Application No. 17/683,339 is a continuation-in-part of application No. 16/866,484, filed on May 4, 2020.
Application No. 16/866,484 is a continuation-in-part of application No. 17/187,871, filed on Feb. 28, 2021.
(60) Provisional application No. 63/217,206, filed on Jun. 30, 2021.
(60) Provisional application No. 63/217,217, filed on Jun. 30, 2021.
(60) Provisional application No. 63/154,746, filed on Feb. 28, 2021.
(60) Provisional application No. 63/217,206, filed on Jun. 30, 2021.
(60) Provisional application No. 62/842,757, filed on May 3, 2019.
(60) Provisional application No. 62/983,486, filed on Feb. 28, 2020.

(51) Int. Cl. G08G 5/00; B64C 39/02; H04L 9/32

(52) U.S. Cl. CPC G08G 5/0091; B64C 39/024; H04L 9/3236; B64C 2201/18; B64C 2201/125

(57) ABSTRACT

A system for providing a universal computing node for use in a smart self-healing node centric blockchain mesh network includes one or more programmable processing components, a communications network interface for communicating over the Internet, one or more local sensors, a blockchain ledger, a data store of useful data from the local sensors, AIML processing components, specific local functions to support one or more local hardware functions, and a local data store. The one or more programmable processing components execute a set of software components within the universal computing node that include a node controller for coordinating the interaction and processing of the set of software components when generating, storing, and retrieving blockchain data records, a web interface for transmitting and receiving data between the universal computing node and one or more additional universal computing nodes and one or more servers connected to the smart self-healing node centric blockchain mesh network, the blockchain processor for generating blockchain data records to be stored within the blockchain ledger, and a sensor interface for receiving data to be stored within one or more blockchain data records.

### CROSS-REFERENCE TO RELATED APPLICATION

This application claims priority to U.S. Patent Application No. 63/217,206, titled “A Universal Computing Node in a Distributed Computing Environment,” and filed on Jun. 30, 2021, and U.S. Patent Application No. 63/217,217, titled “Low-Latency Blockchain Weather Data Exchange,” and filed on Jun. 30, 2021, Attorney Docket No. RG2177.008-US-P1. This application claims priority to U.S. patent application Ser. No. 17/683,339, titled “Autonomous Inspection System Within A Smart Self-Healing Node Centric Blockchain Network For Safety And Quality Management,” and filed on Feb. 28, 2022, Attorney Docket No. RG2177.006-US-01, which itself also claims priority to U.S. Patent Application No. 63/154,746, titled “Artificial Intelligence Machine Learning AIML SMS SRM CRM QMS and Blockchain Cyber Security System for Unmanned Aircraft Vehicles UAV Systems,” filed on Feb. 28, 2021, Attorney Docket No. RG2177.006-US-P1.

This application is also claims priority to related, commonly owned, and pending U.S. patent application Ser. No. 16/866,484, titled “Smart Drone Rooftop and Ground Airport System,” and filed on May 4, 2020, Attorney Docket No. RG2177.007-US-01, that itself claims priority to U.S. Provisional Patent Application No. 62/842,757, filed May 3, 2019, titled “Universal Automated Artificial Intelligence Rooftop UAS/UAV Drone Port/Airport Station For General Purpose Services Of Robotic UAS/UAVS, And Its Supporting Hardware & Equipment Related To: Loading/Unloading Deliveries, Deployment/Arrival, Dispatching, Air Traffic Control, Charging, Storing/Garaging, De-Icing/Anti-Icing, Meteorological & Data Dissemination/Retrieval, Big Data Mining And Mimo Network Services,” Attorney Docket No. RG2177.007-US-P1, and U.S. Provisional patent application Ser. No. 17/187,871, titled “Smart City Smart Drone UAS/UAV//VTOL Mailbox Landing Pad,” filed on Feb. 28, 2021, Attorney Docket No. RG2177.005-US-01, that claims priority to U.S. Provisional Patent Application No. 62/983,486, titled “Smart City Smart Drone UAS/UAV//VTOL Mailbox Landing Pad,” filed Feb. 28, 2020, Attorney Docket No. RG2177.005-US-P1.

This application is related to U.S. Provisional Patent Application, Ser. No. 63/322,579, titled “Smart Delivery Doorbell and Chime Data Blockchain Miner with Crypto and Token Integration and Smart Drone Landing Pad Data Miner,” filed Mar. 22, 2022.

This application is also related to concurrently filed and commonly assigned U.S. patent application Ser. No. ______, titled “A Data Exchange Within a Smart Self-Healing Node Centric Blockchain Network,” Attorney Docket No. RG2177.008-US-01, filed 30 Jun. 2022. All of the above referenced applications are incorporated herein as if recited herein in their entirety.

### TECHNICAL FIELD

This application relates in general to a system for providing distributed computing devices, and more specifically, to a system for providing a universal computing node within a smart self-healing node centric blockchain mesh network.

### BACKGROUND

Distributed processing systems in which applications are performed as smaller operating procedures across a number of processing systems over a geographic area have been growing in functions, complexity, and uses as individual processing systems increase in capabilities while at the same time communications networks allow large amounts of data to be transmitted between these processing systems. This trend has given rise to a number of processing approaches including edge computing, mesh computing, Internet of Things (IoT), and autonomous vehicles operating in a distributed controlled environment.

Currently, all of these different computing devices are uniquely created to perform a particular function. This approach leads to a variety of different computing architectures, instruction sets, and components to be used in these different systems. As such, utilizing idle processing devices as backup, spare or demand-driven processing capacity is stymied as different devices may not always be able to be easily repurposed or used to dynamically replace a processing device when a failure occurs. These issues cause programming, maintaining, and repurposing various components dynamically to be difficult, time consuming, labor intensive, and expensive. All of these issues lead to a slower adoption rate for the distributed processing systems.

Therefore, a need exists for an article of manufacture for providing a universal computing node for use in a distributed computing environment used to support autonomous devices having blockchain processing, AI-machine learning (AIML) processing, and a long-lasting power supply. The present invention attempts to address the limitations and deficiencies in prior solutions according to the principles and example embodiments disclosed herein.

### SUMMARY

In accordance with the present invention, the above and other problems are solved by providing a system for providing a universal computing node within a smart self-healing node centric blockchain mesh network according to the principles and example embodiments disclosed herein.

In one embodiment, the present invention is a system for providing a universal computing node within a smart self-healing node centric blockchain mesh network. The universal computing node includes one or more programmable processing components, a communications network interface for communicating over the Internet, one or more local sensors, a self-healing blockchain data exchange, a data store of useful data from the local sensors and local processing, artificial intelligence and machine learning processing components, specific local functions to support one or more local hardware functions, and a local data store.

In another aspect of the present invention, wherein the self-healing blockchain data exchange has a blockchain ledger containing a plurality of blockchain data records and a blockchain processor for generating each of the blockchain data records containing data stored within the self-healing blockchain data exchange.

In another aspect of the present invention, wherein each of the blockchain data records contains a time stamp data field for storing data and time data associated with the blockchain data record is added into the self-healing blockchain data exchange, a universal node ID field for storing a unique identifier for the universal computing node generating the data is added into the self-healing blockchain data exchange, a blockchain ID for storing a unique identifier for the he blockchain data record is added into the self-healing blockchain data exchange, a data access right field for storing access rights data defining permissible uses for retrieval of each blockchain data record, and a data contents field is added for storing the data within the blockchain data records.

In another aspect of the present invention, the set of universal computing node software components includes a node controller to coordinate the interaction and processing of the set of software components when generating, storing, and retrieving blockchain data records, a web interface for transmitting and receiving data between the universal computing node and one or more additional universal computing nodes and one or more servers connected to the smart self-healing node centric blockchain mesh network, the blockchain processor for generating blockchain data records to be stored within the blockchain ledger, and a sensor interface for receiving data to be stored within one or more blockchain data records.

In another aspect of the present invention, wherein the set of node software components further comprises a wireless interface for transmitting and receiving data between the universal computing node and one or more additional universal computing nodes and one or more servers connected to the smart self-healing node centric blockchain mesh network over a wireless data channel, a storage interface communicatively connecting the set of software components within the universal computing node to semi-permanent data storage devices within the universal computing node, and an app loader/retriever for retrieving programmable software components from a remote application server on the smart self-healing node centric blockchain mesh network to provide the universal computing node with functionality provided by the retrieved programmable software components.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of a distributed computing environment containing a system for providing a universal computing node within a smart self-healing node centric blockchain mesh network according to the present invention.

FIG. 2 illustrates a system for providing a universal computing node within a smart self-healing node centric blockchain mesh network according to the present invention.

FIG. 3 illustrates a functional diagram of a generic computing system that may be used as part of a system for providing a universal computing node within a smart self-healing node centric blockchain mesh network according to the present invention.

FIGS. 4a-c illustrate a computing system of hardware components of various embodiments of a system for providing a universal computing node within a smart self-healing node centric blockchain mesh network according to the present invention.

FIGS. 5a-c illustrate a computing system of software components of various embodiments of a system for providing a universal computing node within a smart self-healing node centric blockchain mesh network according to the present invention.

FIG. 6 illustrates a data exchange validated data record that may be used as part of a system for providing a distributed secure data exchange computing environment used to support a system for providing an unmanned aerial vehicle (UAV)-based inspection system within a smart self-healing node centric blockchain mesh network having blockchain processing according to the present invention.

### DETAILED DESCRIPTION

This application relates in general to a system for providing distributed computing devices and more specifically, to a system for providing a universal computing node within a smart self-healing node centric blockchain mesh network according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “individual” and “user” refer to an entity, e.g., a human, using an article of manufacture providing a universal computing node for use in a distributed computing environment used to support autonomous devices having blockchain processing, AIML processing, and a long-lasting power supply associated with the invention. The term user herein refers to one or more users.

The term “invention” or “present invention” refers to the invention being applied for via the patent application with the title “A Universal Computing Node in a Smart Self-Healing node Centric Blockchain Mesh Network.” Invention may be used interchangeably with computing node.

The term “mobile application” refers to an application executing on a mobile device such as a media player, set-top box, smartphone, tablet, and/or web browser on any computing device.

The term “application programming interface” that is also referred to as “API” refers to a computer programming construct permitting a computing process running on a particular computing device to access software and related operations provided by a third-party running on a separate computing device using a standardized interface and data exchange format. The use of APIs to access third-party software permits development of collaborative computing products in which software components from different sources operate together to implement a processing solution.

The term “unmanned aerial vehicles (UAV)” refers to any embodiment of an UAV device. These UAVs may include, but are not limited to: vertical take-off and landing vehicles (VTOL), electronic vertical take-off and landing vehicles (eVTOL), unmanned ground vehicle (UGV), unmanned aerial systems (UAS), vertical short take-off and landing vehicles (VSTOL), short take-off and landing vehicles (STOL), electric small take-off and landing vehicles (eSTOL), conventional take-off and landing vehicles (CTOL), electric conventional take-off and landing vehicles (eCTOL), autonomous vehicles (AVs), connected and autonomous vehicles, cargo air vehicles (CAV), electric cargo air vehicles (eCAVs), passenger air vehicles (PAVs), hydrogen unmanned vehicles (HUV), hydrogen and electric unmanned vehicle hybrids (HEUVH), and electric passenger air vehicles (ePAVs).

The term “Autonomous Transportation System of Systems,” includes both unmanned traffic management (UTM) fleet operations and drones/UAVs.

The term “UTM fleet operations” refers to a UTM fleet operations traffic management system for stakeholders who manage their own fleets of autonomous vehicles, who will be able to protect their data by being onboarded and integrated into the UAV network. Existing UTMs provide data that cannot be reused with trust by another interested third-party. There is no way to let third-parties know what data is currently available that can be repurposed for use from one or more of self-healing blockchain-based data exchange(s) disclosed herein. The present invention provides an interoperable open software platform in which UTMs can capture the value of this data both for their company and their clients.

The term “drone/UAV providers” refers to robot and manual vehicle manufacturers with sensors such as light detection and ranging (LiDAR), radar, and weather sensor payloads that provide situational awareness either because there is a governing body mandate and/or for an added feature for an additional data solution. Very few existing autonomous delivery transportation stakeholders can sustain the cost of R&D, manufacturing, maintenance, and delivery without continual large cash infusions, which makes the existing models not commercially viable and sustainable without a method by which to offset those costs.

The term “self-healing blockchain-based data exchanges” refers to a data storage device that stores data received for long term usage onto a blockchain ledger using blockchain processing. The data ledger is maintained on a plurality of universal computing nodes as is common in all blockchain processors. These computing nodes are disclosed herein as being interconnected over a distributed computing network using standard data communications protocols. One skilled in the art will recognize that the blockchain ledgers being maintained by multiple universal computing nodes also may be implemented with other comparable communications and secure storage technologies including a L_0 (level zero) distributed network, an HGTP (hypergraph transfer protocol) network, and any other network configuration and protocol.

The term “L_0 distributed network” refers to existing cryptocurrency token standards and decentralized layer 1 protocols such as Ethereum (ETH) and DisCas Vision (DISC) which have high slow latency and vastly fluctuating and high gas fees (transaction fees) to use their networks. The historic data cannot be created at its original source because the data validators in ETH are not providing the full historic blockchain data creation events, when using Proof of Work (PoW) and Proof of Stake (PoS) metrics, which contributes to the high gas fees and latency associated with the various networks. Using this older method, the business models' cost and profit predictability become uncertain for DISC and ETH to produce commercially sustainable and viable blockchain validated and trusted data such as that provided by using a smart self-healing node centric blockchain mesh network, Autonomous Data Infrastructure, and the autonomous mobility data exchange (AMX)/sub-exchange.

This high data latency fluctuation and gas fee dilemma can be solved by a system minting an L_0 token using an HGTP hypergraph network that is a decentralized L_0 protocol network, which requires zero transaction fees, built as a high-volume transaction utility and use cases, with lower latency and scalable solutions. The hypergraph network is built with concurrent consensus mechanisms and is structured using a directed acyclic graph for high bandwidth and throughput needs, thereby allowing for the creation of a scalable business model and metric on top of the hypergraph by attaching a transaction fee to various products, services, and solutions without the cost of layer 1 transaction fees. A crypto user base customer who entered the self-healing blockchain-based data exchange(s) and the hypergraph network, out of layer 1 networks like ETH, will be able to navigate through the smart self-healing node centric blockchain mesh network, the hypergraph network, and associated AMX and lattice exchanges and state channels.

The term “data redefined” refers to creating a commercially viable and sustainable autonomous infrastructure. The present invention introduces a disruptive method by which to evolve the existing manual aviation and vehicle aviation structure and economics into a redefined data structure that will take existing cost-affordable sensors and integrate them into an autonomous system that can be sustained through the use, subsidization, and monetization of trusted data. The present invention has created a solution of repurposing roofs, land, mailboxes, and trusted self-healing blockchain-based data exchanges for the autonomous infrastructure. This architecture must include at minimum, but not be limited to: a system that is data agnostic, data repurposed, Data Depository and Repository, Rooftop and Ground Space Repurposed, Mailboxes and Parcel Mailboxes Repurposed as Smart Mailbox Landing Pads, Real Estate Bundle of Rights, Own the Air Around You with Metadata, Digital Data Bundle of Rights, Discoverable Data with Integrity, Live Data Repurposed, Historic Data Repurposed, Existing Infrastructure Repurposed©, digital twins, metaverse, and non-fungible tokens (NFTs).

The term “data agnostic” refers to allowing for all types of industry-accepted data formats to be universally accepted in the node network. The smart self-healing node centric blockchain mesh network offers a delivery drone app and data exchange that is hardware/software agnostic on an interoperable, scalable, and open platform.

The term “data repurposed (repurposed data)” refers to taking existing data that has been used for its purpose and/or stored for memorialization and repurposing it to be sold on discoverable self-healing blockchain-based data exchanges for subsidization and/or monetization of hard and soft costs.

The term “data depository and repository” refers to assigning data to be used for something other than its original purpose by uploading the data into a data storage depository or repository for future monetization. Repurposed data means recurring and residual income opportunities.

The term “rooftop and ground space repurposed” refers to residential, commercial, industrial rooftops and parking spaces that can be repurposed as a part of the autonomous infrastructure. By repurposing existing and previously worthless rooftop and ground space, the smart self-healing node centric blockchain mesh network creates a multi-modal autonomous infrastructure consisting of nodes (machines, sensors, drones, landing pads, charging stations, VTOLs, UGVs, robots, etc.) necessary to create True Last Mile Logistics™ and fill the data gaps that government and existing airport waypoints cannot fulfill. Using existing rooftops and ground infrastructure, the system can create daisy-chained fusion weather data points, delivery waypoints and smart drone VTOL and UGV True Last Mile Logistics™ airports by using existing unused and once worthless real estate.

The term “mailboxes and parcel mailboxes repurposed” as Smart Mailbox Landing Pads™” refers to repurposing existing federally-regulated mailboxes to integrate a Smart Mailbox Landing Pad™ into an existing shipping logistics infrastructure that can provide point-to-point blockchain validated AIML edge computing and point-to-cloud communications. Smart Mailbox Landing Pads™ create delivery waypoints for customers. The smart self-healing node centric blockchain mesh network can close the loop of a full turn-key utility autonomous drone, vehicle, and robot delivery process. This also will allow for existing manual operators to benefit from avoiding the grounding of their planned flight operations by taking existing node data from the departure waypoint, enroute waypoints and arrival waypoint of the landing pad, and figure out how to avoid any adverse weather being reported on existing sensors to maintain operations without grounding the vehicles.

The term “own the air around you with metadata” refers to users controlling the metadata produced and offering it with rewards by participating in gamification programs.

The term “Digital Data Bundle of Rights™” refers to the digital data bundle of rights that provide for rights and or privileges that can be divided by use, terms, and ownership, among other privileges and rights. The present invention provides for a back-office dashboard where a data supplier can provide data that is assigned specific terms that will allow for a data acquisition user to agree to. For example, a data supplier may upload an NFT and state that a 72 DPI image can be purchased outright for a certain price, but 300 DPI is only available by lease for a limited time. That same file can provide for the option to buy the data as HD quality, but only if it is used for a digital twin project that will provide for royalty licensing rights. The file also can provide for fractional ownership of the NFT if it is 1200 DPI. The data supplier could even reserve anything that is 600 DPI for a charitable donation and still use the same 600 DPI as only available as a touch point licensing on IoT-only hardware. Determining the Digital Data Bundle of Rights© for terms and conditions of the digital data use and/or ownership will be limited to the imagination and capability of the data. The dashboard will be scalable as the terms evolve. The type of data and/or use of data is agnostic and interoperable. Any data is monetizable or can be provided for free: dynamic and or static data, data types, files, formats, video, audio, communication frequencies, spectrums, etc.

The term “discoverable data with integrity” refers to blockchain validated data that may be trusted as reliable data because it can be traced to its original data supplier and throughout the sales and use process through a self-healing blockchain-based data exchange. This Discoverable Data with Integrity™ allows for the purposing and repurposing of trusted data as a service.

The term “live data repurposed” refers to the use of live data that has no purpose to be saved and repurposed on the self-healing blockchain-based data exchange for subsidization and monetization.

The term “historic data repurposed” refers to using historic data that has no purpose other than to be stored for future review and to be saved if and until then, to be repurposed on the self-healing blockchain-based data exchange for subsidization and monetization.

The term “existing infrastructure repurposed” refers to using existing commercial building structures, postal delivery, and transportation infrastructures for the newly created autonomous infrastructure to be ecofriendly.

The term “digital twins” refers to the digital twin model of user's data, that will subsidize and or monetize the value of it via the AMX as markets start to understand the value of this digital data.

The term “metaverse” refers to an artificial digital environment that will provide for entire cities, small size-towns, countries, and worlds. This can be sold on the AMX data exchange.

The term “non-fungible tokens” (NFTs) refers to digital instruments that will allow for data suppliers and data creators to take their data that would normally be tossed away after an inspection, surveillance or delivery for example, and either direct stream the data into the exchange database depository or repository and “purpose” the raw validated data and or “repurpose” the raw and or modeled verified data, to be used within the self-healing blockchain-based data exchange. As data producers and suppliers start to develop photo images, videos and/or models, such as digital twin cities, that they wish to sell, lease and/or license, but have decided to declare it as an original, unique, and one-of-a-kind digital data work product, that they will not reproduce, they will be able to do so via the NFT portion of the self-healing blockchain-based data exchange.

The term “NFT Bundle of Rights™ (NFTBOR)” refers to taking a piece of that NTF bundle for various uses. For example, users may want to keep the use of the land, but sell the mineral rights. Users may want to lease the land itself. If a user has declared an original digital data as something the user will not reproduce and want it to be sold as an NFT, that data is the user's property to do with it as he/she would any piece of real estate. However, old NFTs simply allow for the data to be sold off in pieces under smart contracts with fractional or full token share sales and purchases. A user could take a digital photo for example and offer it for sale, lease and/or license. Users can take that even further by saying that the NFT can be free to the public for one purpose and/or use, but must be purchased for another use and leased for even another. Users can even make them options and/or licensing rights with a balloon expiration date. This maximizes the NFT monetization opportunity to its fullest. There is no limit to the types of digital data one can use as an NFT and declare as a NFTBOR asset.

The term “open platform and interoperable sensor participation” refers to data fusion between data sets of diverse sensor data that will be possible as data sensor nodes on the self-healing blockchain-based data exchange are onboarded. Users can add to their existing raw data and or model data by purchasing, leasing, and licensing the data as a layered solution for their new value-added data offered on the self-healing blockchain-based data exchange.

The term “near real time data” refers to allowing universal computing nodes to be able to have a consensus between each other using a decentralized and distributed validation solution.

The term “historic data repository” refers to a storage location in which historic data can be submitted as a repository on the self-healing blockchain-based data exchange to provide for a data storage solution.

The term “discoverable data” refers to data integration and aggregation allowing for data depositories and repositories to be managed, to be discoverable, and to be accessible through an industry-specific data exchange query.

The term “Discoverable Trusted Verified Data with Integrity™” refers to self-healing blockchain-based data exchange(s) combined with a hypergraph and digital wallet, that will be an agnostic range in data formats, and uses, but is not limited to: live data, raw data, modeled data, historic data, static and dynamic data, digital twin data, metaverse data, non-fungible tokens (NFTs), non-fungible token bundle of rights (NFTBOR) data, telemetry data, remote data, stand-by data, and the like. The smart self-healing node centric blockchain mesh network takes into consideration the following when creating a self-healing blockchain-based data exchange for a user's data. This data has integrity data, immutable data, data chain of custody and memorization of events, data subsidization and monetization, smart shipping container and nodes, and a L_0 distributed network.

The term “integrity data” refers to data that has been blockchain validated to its original source as encrypted trusted data.

The term “immutable data” refers to smart contract blockchain encrypted data.

The term “data chain of custody and memorization of events” refers to each block of data mined, blockchain validated, encrypted, and monetized with a smart contract and data validation by proof of reputation, but can work with PoW and PoS networks. Allowing for all data to be tracked through a chain of custody via blockchain validation, to provide for the data's original source, where it is and where it has gone permits the creating data supplier to always know where their data is and be compensated for its use.

The term “data subsidization and monetization” refers to trusted, blockchain-validated data that can be created for the purpose and/or the repurpose to be sold on the AMXs to subsidize and or monetize the data.

The term “smart shipping container and nodes” refers to autonomous air, ground and marine vehicles that will eventually be required to monitor and log all internal and external activity related to a transported container for safety and security. Containers come in all shapes and sizes. The smart self-healing node centric blockchain mesh network looks as these transportation multimodal opportunities to evolve the containers into Smart Shipping Containers, Smart Cargo Containers, Smart Drone Containers, Smart Truck Containers, Smart Train Containers, Smart VTOL Containers, Smart Marine Containers, Smart Boat Containers, Smart Car Containers, Smart Travel Containers, etc., that allow for security, security risk assessment, situational awareness, content monitoring, and observation and memorialization using sensor data both inside and outside of the container. The container business will need to evolve with edge and point-to-cloud data availability.

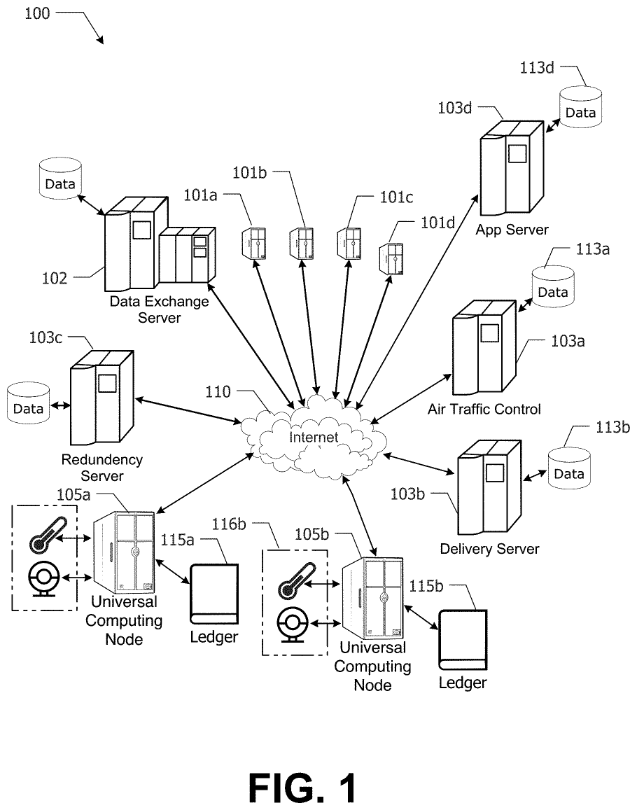

In general, the present disclosure relates to a system for providing a universal computing node within a smart self-healing node centric blockchain mesh network according to the present invention. To better understand the present invention, FIG. 1 illustrates an example embodiment of a distributed computing environment containing a system for providing a universal computing node within a smart self-healing node centric blockchain mesh network according to the present invention. The inspection system 100 communicatively couples a plurality of universal computing nodes 101a-d and 115a-b to a set of servers including a data exchange server 102, an air traffic control server 103a, a UAV delivery server 103b, an app server 103c, a node redundancy server 103d, and other relevant servers as part of a smart self-healing node centric blockchain mesh network 101. The universal nodes 101a-d and 115a-b are described in detail in the previously referenced concurrently filed US patent application. The air traffic control server 103a, a UAV delivery server 103b, an app server 103c, a node redundancy server 103d, and the data exchange server 102 also are described in detail in the above US patent application. The delivery server 103b performs package pickup and delivery dispatch services including logging the UAV flights and deliveries as well as works with the air traffic control server 103a for flight trip route planning, in-air flight monitoring, and related air traffic control operations. All of these examples are associated with an example embodiment of a self-healing blockchain-based data exchange according to the present invention.

The universal computing nodes 105a-b are shown having a plurality of attached sensors 116a-b that generate data to be validated and included within the self-healing blockchain-based data exchange 121. The validated data is stored within the blockchain ledgers 115a-n that can be searched by users as described herein in reference to FIG. 7 below.

One example of the benefits of a decentralized self-healing blockchain-based data exchange can be demonstrated in aviation as it relates to weather and flight planning. Existing weather sensor data is relied upon by public and private sector airports and aviation pilots throughout the world. However, there are data gaps between airports that do not allow for pilots to confidently rely on their flights to have accurate weather and situational awareness beyond the sensor's existing distributed data distance capabilities. This leaves the burden of adverse weather mitigation up to the pilot to differentiate between what might be a life-threatening situation that may be too late to divert from without adequate notice. Additionally, UAVs are authorized to fly from surface (AGL) to 400 feet. Satellite capabilities lose strength and reliability between 3000-5000 feet from the surface.

The redundancy server 103c controls and communicates with all of the universal computing nodes 101a-d, 105a-b on the smart self-healing node centric blockchain mesh network 131. The redundancy server 103c may detect a failure of an active universal computing node 105a from a failure to respond to communications with any other universal computing node in the smart self-healing node centric blockchain mesh network 131. The redundancy server 103c also may be informed of a failure of one or more components, including sensors, by an active universal computing node 105a on the smart self-healing node centric blockchain mesh network 131. Whenever a failure occurs, the redundancy server 103c determines the sensors attached to the universal computing node 105a that has the failure as well as determines the functions performed by this universal computing node 105a within the smart self-healing node centric blockchain mesh network 131.

With this information, the redundancy server 103c identifies other universal computing nodes 105b within the smart self-healing node centric blockchain mesh network 131 that may replace the functionality of the failed computing node and coordinates the failover of the existing functions of the failed computing node to its replacement node. This failover may include transferring any data stored within the failed node to the replacement node The failover also may include transmitting a message to one or more universal computing nodes and servers within the smart self-healing node centric blockchain mesh network 131 that the failover is occurring. The other nodes within the smart self-healing node centric blockchain mesh network 131 may update their configuration data to address all data requests and related communications that had been assigned to the replacement computing node. As such, the entire smart self-healing node centric blockchain mesh network 131 continues to operate after a brief failover as if the failure had not occurred.

It should be noted that the present invention uses self-healing blockchain-based data exchanges disclosed within the commonly assigned US patent application referenced herein to store all of the data found on each universal computing node in the preferred embodiment. As disclosed herein, the self-healing blockchain-based data exchanges utilize a blockchain ledger 115a to store this data for retrieval upon request. Because a blockchain ledger 115a automatically transfers all blockchain records 500, as described below, to multiple universal computing nodes to be added to multiple copies of any particular blockchain ledger 115a, and because a blockchain record 500 is not included into a blockchain ledger 115a until the inclusion of the record has generated a matching blockchain checksum or similarly computed value generated from the addition of the record to the ledger, very little data is expected to be transferred from a failing computing node to its replacement node as part of the failover process. Data redundancy and availability is automatically maintained by the smart self-healing node centric blockchain mesh network 131 with the use of the blockchain ledgers.

The redundancy server 103c may maintain a failover database 113c that contains rules for how particular node failures are to be handled. These rules may be specified for each individual universal computing node within the smart self-healing node centric blockchain mesh network 131 or may be specified by groups of similarly functioning universal computing nodes as appropriate. The redundancy server 103c may generate messages to system operators, node and self-healing blockchain-based data exchange owners, and any other interested party to inform these individuals of the failover event. The transmission of these messages may initiate a service request for maintenance and repair of the universal computing node that has caused the failover event.

The delivery server 103b provides external users access to the system 100 to request and schedule the services of a UAV 125 to perform a flight on their behalf. With respect to the inspection system 100, the delivery server 103b provides an ordering and scheduling service to cause a UAV 125 to schedule a flight to inspect a location of an object. The request may include requirements of the UAV 125 such as the resolution and characteristic of the imaging device contained within the UAV 125, the range and ability to plan a flight to a location over a particular flight path, and the available schedule for a flight that meets any time or weather requirements of the user requesting the inspection to be performed. The delivery server 103a may coordinate the creation of a flight path with the air traffic controller server 103a. All of the data associated with the request for a flight, its scheduling, its status, and results may be maintained within a self-healing blockchain-based data exchange as otherwise disclosed herein for use by the repair report generator 154 and any other use of the self-healing blockchain-based data exchange.

Examples of systems that may be implemented using a set of processing nodes 110-113 including autonomous flying devices that utilize computing nodes are described in more detail in U.S. patent application Ser. No. 16/866,484, titled “Smart Drone Rooftop and Ground Airport System,” and filed on May 4, 2020, that itself claims priority to U.S. Provisional Patent Application No. 62/842,757, filed May 3, 2019, titled “Universal Automated Artificial Intelligence Rooftop UAS/UAV Drone Port/Airport Station For General Purpose Services Of Robotic UAS/UAVS, And Its Supporting Hardware & Equipment Related To: Loading/Unloading Deliveries, Deployment/Arrival, Dispatching, Air Traffic Control, Charging, Storing/Garaging, De-Icing/Anti-Icing, Meteorological & Data Dissemination/Retrieval, Big Data Mining And Mimo Network Services” and U.S. Provisional patent application Ser. No. 17/187,871, titled “Smart City Smart Drone UAS/UAV/VTOL Mailbox Landing Pad” filed on Feb. 28, 2021, that claims priority to U.S. Provisional Patent Application No. 62/983,486, titled “Smart City Smart Drone UAS/UAV/VTOL Mailbox Landing Pad,” filed Feb. 28, 2020. All of these applications are incorporated herein as if recited herein in their entirety.

The present invention addresses the limitations of prior solutions to these problems while working with other components of a Smart Drone Rooftop and Ground Airport System and the Smart Mailbox Landing Pad IP system. Using its AIML in a delivery drone network and the universal computing nodes in a distributed computing environment will allow for the communication of sensors that are strategically positioned on top of existing building rooftops and vacant ground surroundings that have been repurposed as drone and vertical takeoff and landing vehicle (VTOL) smart airport/vertiport infrastructure. Each time a smart drone airport/vertiport is added to a roof national air space is safer, and each time integrated sensors are daisy chained on smart airport/vertiports data gaps are filled between existing airports. Operators of aircraft, drones, UAVs 125, and robots will be able to rely on decentralized weather data, once not available, and will be willing to pay for it because it has been validated. Operation of this system is described in detail in the related US patent applications cited above.

One of ordinary skill in the art will recognize that the above applications of universal computing node technology within a distributed processing system in support of autonomous flying devices may also be used in autonomous marine and ground-based environments in similar ways. Additionally, the use of universal computing node technology within a distributed processing system may be used to solve other data processing problems that arise as data is collected from sensors located across a large geographic area while the data from all of these sensors may be combined to represent data across the large geographic area at varying resolutions.

For example, local weather data may be collected from environmental sensors located adjacent to the distributed processing nodes that may be useful for autonomous devices within the geographic area at a fine resolution to operate as weather condition changes. The same weather data may be combined at a coarser resolution for route planning of the autonomous devices across the geographic area in a weather daisy-chained architecture. Even larger resolution weather data may be used for applications at regional and national levels. Use of the distributed processing nodes to process the raw weather data in increasingly larger areas with larger resolution allows all of these data representations of the same weather data to be generated using processing and data-combining algorithms in a number of computing nodes. This processing utilizes the combined processing capacity of all of the computing nodes to permit large amounts of data to be processed simultaneously that may generate near-real time results for all of these levels of usage. Of course, similar applications to the weather processing from many other industries are easily supported in similar manners.

Additionally, the provision of a self-healing blockchain-based data exchange used in an autonomous UAV delivery system is one example embodiment of a self-healing blockchain-based data exchange that may be implemented by the present invention. The sensor data of the universal computing node obtained at the edge of a distributed computing environment may be any generated data that may be processed and stored onto a blockchain ledger. The generated data may be validated as disclosed herein to become validated data that may be trusted to the extent that the operator of the particular computing node generating the data may be a trusted source of data. The validated data, regardless of content, may be searched and identified using the metadata as disclosed herein. The validated data also may be acquired with a set of access rights as disclosed herein. The present invention is not intended to be limited to any particular example embodiment described here and is defined by the limitations recited within the attached claims.

The data exchange server 102 has positioned itself to be hardware (node) and software agnostic. The open platform is a scalable, interoperable, and modular autonomous node centric blockchain mesh network infrastructure of blockchain verified data, which can be daisy chained for situational awareness and detect and avoid features between nodes such as autonomous drones, manned aircraft, and manned and unmanned ground vehicle sensors, landing pads, vertiports, charging stations, drone ports, and other infrastructure hardware. This creates a BVLOS commercially viable and sustainable solution for the UAV and other industries. The Vertiport-in-a-Box (ViB) solution allows the system to integrate custom use case partners that provide autonomous hardware for air, ground and marine vehicles, and software data sensors using our node application.

More generically, the present invention provides the first true data exchange. In order to provide for a decentralized location where data can be discoverable and queried, an AMX will support an autonomous market maker data exchange for data suppliers and data acquisition users. This self-healing blockchain-based data exchange will be launched from the Lattice Launch Pad™, where AMX will have multiple industry specific self-healing blockchain-based data exchanges which will come out in stages. These self-healing blockchain-based data exchanges are the combination of being AMX Pools, AMX Network Architecture, and AMX Sub-Exchanges.

The AMX Pools use token economics for token pools for specific categories. AMX will use sub-exchange proposal pools, data supplier access pools, user access pools, and user supplier pools.

The AMX architecture must have the flexibility and dexterity of an open network platform and token exchange. The present invention models both provided this solution. Key elements to achieve this goal are for the architecture to be industry decentralized (DeFi), data agnostic, open platform, interoperable, modular, scalable, multi exchange data storage for the depository and repository of data, data-on-demand, static data, and dynamic data.

The AMX also provides for industry specific sub-exchanges and cross-sub-exchanges. These self-healing blockchain-based data exchanges include a weather data exchange, a drone delivery data exchange, and industry specific sub-exchanges. These industry specific exchanges will allow for data to be discoverable on a specific exchange. The AMX architecture also will allow users to repurpose data on multiple industry exchanges.

An HGTP horizontal hypergraph requires projects to create liquidity and bandwidth pools to access the network and create liquidity of L_0 tokens. The present invention requires liquidity and bandwidth support for its smart delivery drone mobile application. Through a staking program, the present invention provides liquidity providers rewards with tokens as APY.Finance tokens. The Platform Community Token Rewards program will be used to support the liquidity pool. As a data provider onboards, for example, a traditional and non-traditional manual and autonomous smart drone, smart landing Pad™, smart mailbox landing Pad™, smart charging station, smart Container©, UGV, robot, eVTOL, UMV, sensors, mobile driver and user apps as a hardware node to the network, the needed throughput on the hypergraph network will be increased and supported. The present invention provides these node solutions through its smart self-healing node centric blockchain mesh network in collaboration with the Hypergraph network. The cross-connection of the nodes communicating also allows for AIML.

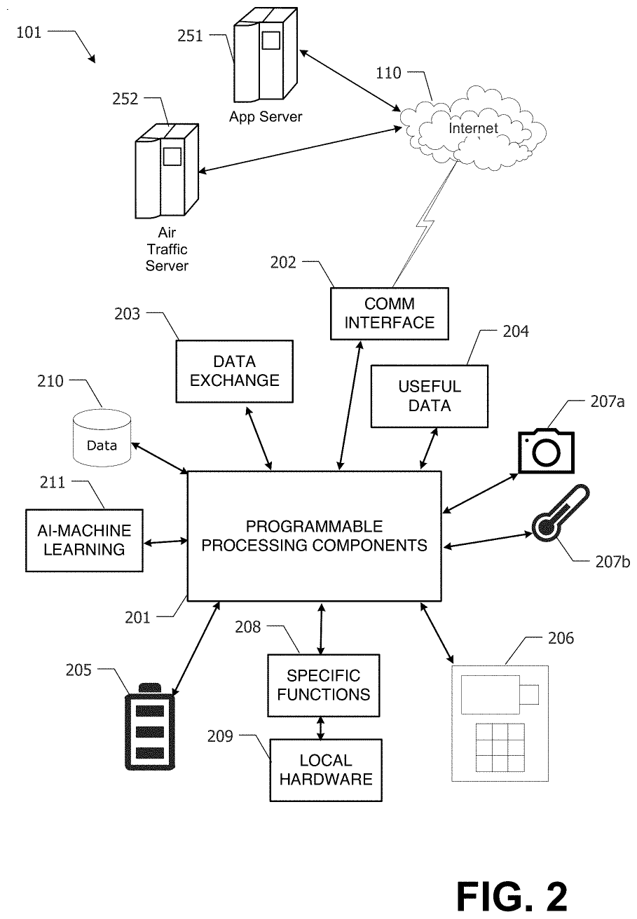

FIG. 2 illustrates a system providing a universal computing node within a smart self-healing node centric blockchain mesh network according to the present invention. A universal computing node 105a may operate to perform any function that may be implemented in software containing executable instructions contained within an application. The computing node 105a may receive an application from a remote source such as an application server 103c that may work with local hardware 209 and local input devices such as imaging devices 207a and weather sensors 207b. The utilization of the application server 103c permits the development and usage of additional devices attached to the computing node 105a as needed to perform desired functions. The local hardware 209 and local input devices 207a-b permit inclusion of additional components that permit the computing node 101 to be universal in its possible functions.

The computing node 105a as disclosed herein is within a larger system that supports the use of UAVs 125 to perform autonomous deliveries of packages from vendors to purchasers used in the smart mailbox landing pads to accept deliveries and provide pickup locations of these packages as disclosed within the above cited and pending US patent application. The smart mailbox landing pads perform all of the functions to communicate with a UAV device 125 as it approaches the smart mailbox landing Pad™ to make a delivery including identification and authorization to land and deliver packages as well as provide secure retention of the delivered packages until retrieved by a user. Any particular smart mailbox landing Pad™ is typically in use a small portion of the time and for most instances the computing node 105a within the smart mailbox landing Pad™ is available for other purposes.

The computing node 105a supports these other purposes by permitting the attachment of the local hardware 209 and the local input devices 207a-b to provide data to be generated for use by the UAVs 125 and related air traffic server 103a functions needed by the UAVs 125. For example, the local input devices 207a-b may include any number of weather sensors 207b including temperature, wind speed, air pressure, humidity, precipitation, and the like. The local input devices 207a-b may also include an imaging device 207a that can provide real time images of present weather, road conditions, and traffic levels around the smart mailbox landing Pad™. Because the smart mailbox landing Pads™ are typically located throughout a geographic area in which users are located, the inclusion of the local input devices 207a and weather sensors 207b is capable of providing critical real time data for the UAVs 125 and the air traffic servers 103a when planning and monitoring the flight paths of the UAVs 125 as they occur.

All of the data generated by the computing node 105a may be transmitted to other computing nodes and servers for use as appropriate. The generated data also may be included within a secure data exchange for possible sale and use by any other computing system. Details of the self-healing blockchain-based data exchanges are described in detail in commonly assigned and concurrently filed US Patent application entitled “A Data Exchange Within a Smart Self-Healing Node Centric Blockchain Mesh Network,” Attorney Docket Number RG2177.009-US-01, Ser. No. ______ filed on 30 Jun. 2022. This concurrently filed application is incorporated hereto in its entirety. Additionally, the computing node 105a may also provide general computing capacity including computing operations and data storage that may be sold to other users in need of these services. As such, the computing capacity of the computing nodes 101 which is available when a UAV 125 is not engaged with the computing node 105a is repurposed for these other uses.

Additionally, the functions performed by the computing nodes 101 may change over time as needed. The computing node 105a may download multiple applications from the application server 103c and time share the computing capacity of the computing node 105a to support different computing usages. The computing nodes 105a also may be within the UAVs 125 in which the local hardware 209 and the local input devices 207a-b correspond to the flight data inputs and flight controls of the UAVs 125 needed to proceed along a flight path. Of course, the computing nodes 105a may also be used in other devices and locations other than smart mailbox landing Pads™.

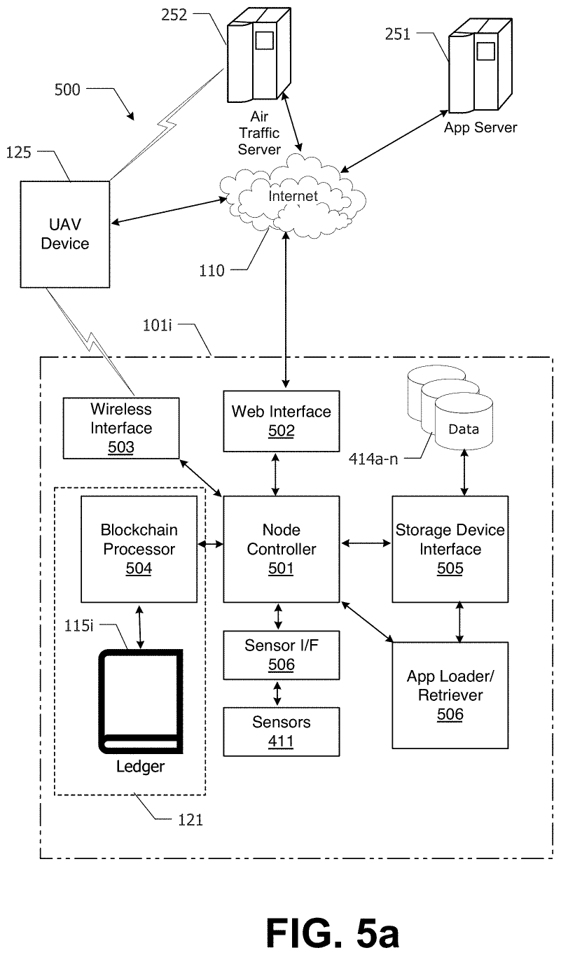

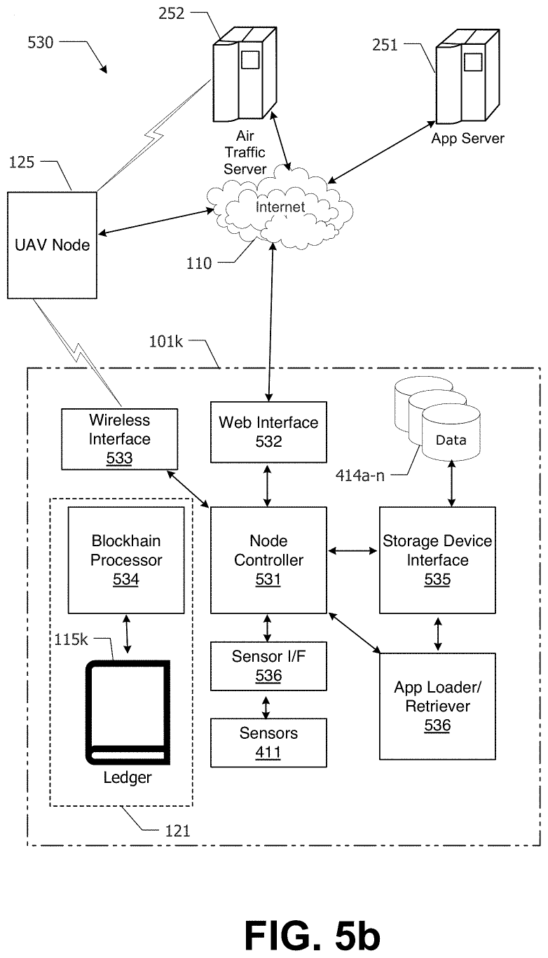

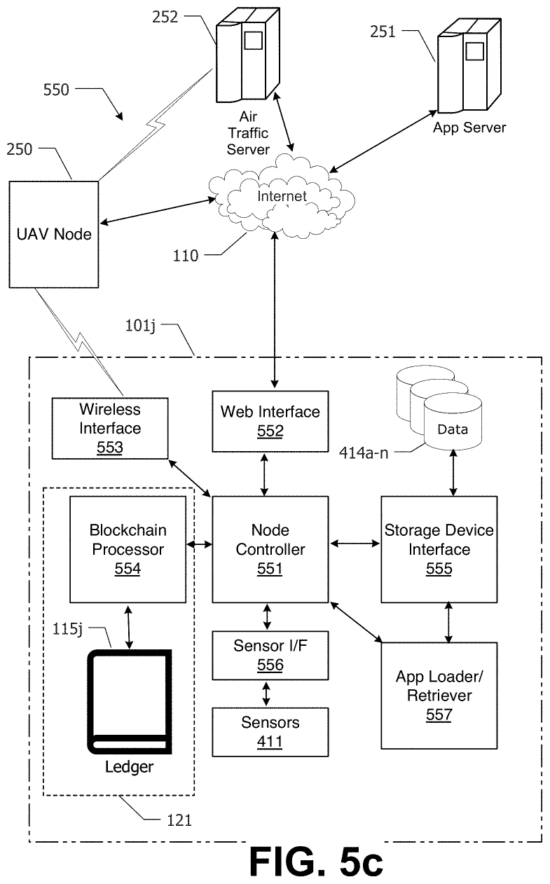

Additionally, the functions of the computing nodes 105a may utilize AIML using the sensor data 207a-b of the computing nodes 101 to determine operation of the computing nodes 105a when similar conditions arise within the sensor data 207a-b. The applications downloaded by the computing nodes may include and/or utilize these AIML functions throughout the operation of the computing nodes and its software components of FIGS. 5a-c.

A computing node 105a of FIG. 2 may be constructed using one or more components including a set of programmable processing components 201, a communications interface 202, a blockchain ledger 203, useful data 204, a power source 205, an input control device 206, one or more external sensors 207a-b, a set of specific processing functions 208, local hardware components 209, local data storage 210, and AI-machine learning functions 211.

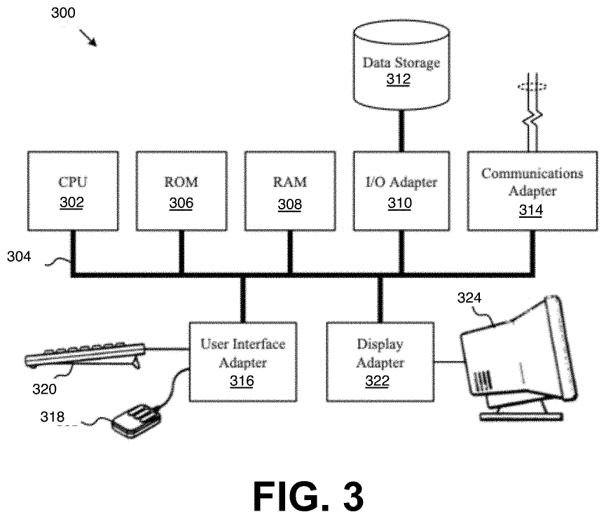

The set of programmable processing components 201 includes all of the programmable hardware and memory used to create a computing device that may operate as a computing node 101. A computing system is described in more detail with regards to FIG. 3 below.

The communications interface 202 permits the programmable processing components 201 to communicate with remote user computing devices 102a-b and 101a-w. The communications interface 202 performs all of the data formatting, computer-to-computer communications, encryption processing, and all similar operations needed by the programmable processing components 201 to communicate with other nodes 101a-w and servers 102a-b.

The blockchain ledger 203 is a data storage system that is used to capture, mine, validate, log or ledger, and maintain data onto a blockchain-based ledger for retrieval by the computing nodes 101a-w and other computing systems. The blockchain ledger 203 contains blocks of encrypted data and uses blockchain processing to ensure that the data retrieved from the ledger 203 is accurate and not corrupted. Blockchain processing stores data in multiple blockchain ledgers on different computing systems using all entries in the ledger in the computation of data stored into each block of data stored on the ledger such that any changes to a data entry in one of the data blocks added to the blockchain ledger 203 will cause all subsequently added data blocks to identify an error when retrieved and decrypted. A simplified description of blockchain processing may be found at https://www.linkedin.com/pulse/how-does-blockchain-work-dummies-explained-simply-collin-thompson/ which is incorporated herein in its entirety.

Because blockchain ledgers 203 require identical ledgers be maintained in multiple computing systems, inclusion of a blockchain ledger 203 in each of the computing nodes 101a-w provides distributed processing systems that run in parallel to maintain the multiple copies of a particular ledger. A data block retrieved from the blockchain ledger 203 that matches a copy of the same data blocks from other computing nodes may be trusted to be an accurate copy of the data block when stored onto the blockchain ledger 203.

Blockchain ledgers 203 may be used to store any type of data that is generated or processed by computing systems. In the systems noted above that relate to autonomous devices, a blockchain ledger 203 may be useful to record data of the various flights of the autonomous flying devices, including date and time of each flight segment from a point of takeoff, a point of a destination, locations of any waypoints followed in a flight, weather data associated with the particular flight, and any information regarding the purpose of the flight, the cargo transported in the particular flight, and any point of sale information related to the cargo. As noted in the autonomous flying device descriptions, the computing nodes may be associated with rooftop airports, smart mailbox landing Pads™, and related devices that are spatially distributed across a geographical area that have functions associated with the distributed devices that have computer control functions. The blockchain ledgers 203 and associated processing may proceed as background processing functions when the computing nodes 101a-d are not needed by the autonomous flying device control system.

Useful data 204 may be generated by each computing node 101a-d based upon the functions and devices that are part of a particular computing node. For example, a computing node 101 may collect local data from attached sensors 207a-b to computing nodes 105a that are spatially distributed across a geographical area. Real-time weather data is one type of data that may be captured at a large number of computing nodes 105a across a geographical area. All of this weather data from all of the computing nodes 101a-d may be combined into a real-time view of weather conditions across the geographical area. This weather data may be combined into a common weather map using a set of processing nodes 110-113. This weather map may be useful to an autonomous flying device control network; additionally, this weather map data may be useful to other users on the Internet 110. As such, the weather maps may represent one type of useful data that is generated and maintained in a computing node 105a that may be provided to other systems to increase revenue generated by the set of processing nodes 110-113.

The power source 205 may be used to provide electrical energy to operate the computing node 105a, any attached sensors 207a-n, local hardware components 209, and network communication functions associated with each computing node 105a. Certain computing nodes 105a and related attached devices may be located when a power connection to a power grid is difficult and expensive. Additionally, other computing nodes 105a, such as computing nodes 105a that are part of UAVs 125, may be mobile devices that require a self-contained power source. The power source of the present invention 205 may comprise a Tritium™-based power source that provides a power source having a long useful life providing electrical power. Examples of these power sources many include many types of self-charging, nano-diamond, and diamond nuclear voltaic batteries. Other long-life power sources include solar-powered devices, hydrogen power generating devices, and similar nuclear-based power sources with a useful long life.

The input control device 206 provides input and output processing to provide operators of the computing nodes with messages and data needed to control the operation of the computing node 105a and its functions. This input control device 206 also accepts commands from a user to instruct the application in the computing node 105a to perform particular tasks.

The one or more external sensors 207a-b may be connected to each computing node 105a to provide data that may be useful for the functions performed by a particular node. As noted above, a computing node 105a may collect local data from attached sensors 207a-b to computing nodes 105a that are spatially distributed across a geographical area. This local data may include images, video, and audio data from a camera device 207a that provide a real-time view of an area about the computing node 105a. This local data also may include weather data from sensors 207b that measure weather data including temperature, wind speed and direction, humidity, barometric pressure, and precipitation, among other data values. The computing node 105a may collect the data values from these sensors 207a-b to provide to other computing devices on the Internet 110 as well as use the data values to generate other data that may be useful to other processing nodes 101a-d and other computing devices.

The set of specific processing functions 208 may be part of a computing node 105a to control local hardware components 209 that are part of the location of the computing node 101. For example, a computing node 105a may be part of a rooftop airport or a smart mailbox landing Pad™ that are used to launch and receive autonomous flying devices. The airports and smart mailboxes may require processing functions to communicate with the autonomous flying devices as part of the control of these flying devices. Additionally, a smart mailbox may include components that open and close to provide storage for mail and packages to be received when an autonomous flying device arrives at the smart mailbox. The set of specific processing functions 208 may control the operation of the smart mailbox as well as notify a user of the arrival of a package as appropriate. The set of specific processing functions 208 provides all processing functions to support the devices that are associated with the computing node 105a at a particular location.

The local hardware components 209 are the physical components to permit the computing node to operate as a specific device. For example, a smart mailbox, as noted above, may have devices to communicate with the autonomous devices, to accept packages from the autonomous devices, and communicate with users about arrival of a package by the smart mailbox. These local hardware components 209 are used to allow the computing node 105a to function as any particular device or system.

The local data storage 210 contains semi-permanent and permanent data storage devices to store data used by software applications executed by the computing node 105a, store and provide data as needed to the software applications executed by the computing node 105a, and store various software applications that may be used to dynamically configure a computing node 105a from one set of processing functions to another set of processing functions. The local data storage may be contained within devices attached to the location of the computing node 105a as well as be contained within devices communicatively connected to the computing node 105a over the Internet 110.

The AI-machine learning functions 211 may be included within a computing node 105a to assist in functions to be performed by the computing node 105a and its attached devices. As the state of AI-machine learning functions continues to mature, the inclusion of these functions may be useful in a large number of different uses. For example, computing nodes 105a that are part of an autonomous device network may include a number of functions associated with the control of the autonomous devices, the routing of the autonomous device travel paths, the detection of dangerous conditions associated with local weather conditions and possible in-route collisions, situational awareness for detection and avoidance of possible collisions between the autonomous devices, and dynamic rerouting of autonomous devices as needed. All of these processing functions may benefit from the use of AI-machine learning functions 211 to provide improved functioning of the computing node 105a based upon data obtained from the particular location of the computing node 105a.

For the example embodiments disclosed herein, the universal computing nodes are disclosed as the computing devices may be used in a system of UAVs working in combination with Smart Mailbox Landing Pads™ and Rooftop UAV Airports and Landing Pads™ as disclosed above. These universal computing nodes may also collect and share local weather data at the corresponding universal computing nodes for use by the UAV and related systems as well as providing data to be included within a weather data exchange as described in detail in a commonly owned and concurrently filed US Patent application entitled “A Data Exchange Within a Smart Self-Healing Node Centric Blockchain Mesh Network,” Attorney Docket Number RG2177.009-US-01, Ser. No. ______ filed on 30 Jun. 2022. This concurrently filed application is incorporated hereto in its entirety. One of ordinary skill in the art will recognize that the universal computing nodes also may be used in many other distributed computing systems and self-healing blockchain-based data exchanges. The embodiments of the UAV systems and weather data exchange are described as representative example embodiments of the present invention. These embodiments are not intended to limit the scope of the present invention except as recited in the limitations of the attached claims.

FIG. 3 illustrates a functional diagram of a generic computing system that may be used as part of a system providing a universal computing node within a smart self-healing node centric blockchain mesh network according to the present invention. FIG. 3 illustrates a computer system 300 adapted according to certain embodiments of the server and/or the user interface device for use as a distributed computing node according to the present invention. The central processing unit (“CPU”) 802 is coupled to the system bus 334. The CPU 302 may be a general purpose CPU or microprocessor, graphics processing unit (“GPU”), and/or microcontroller. The present embodiments are not restricted by the architecture of the CPU 302 so long as the CPU 302, whether directly or indirectly, supports the operations as described herein. The CPU 302 may execute the various logical instructions according to the present embodiments.

The computer system 300 also may include random access memory (RAM) 308, which may be synchronous RAM (SRAM), dynamic RAM (DRAM), synchronous dynamic RAM (SDRAM), or the like. The computer system 300 may utilize RAM 308 to store the various data structures used by a software application. The computer system 300 may also include read only memory (ROM) 306 which may be PROM, EPROM, EEPROM, optical storage, or the like. The ROM may store configuration information for booting the computer system 300. The RAM 308 and the ROM 306 hold user and system data, and both the RAM 308 and the ROM 306 may be randomly accessed.

The computer system 300 also may include an input/output (I/O) adapter 310, a communications adapter 314, a user interface adapter 316, and a display adapter 322. The I/O adapter 310 and/or the user interface adapter 316 may, in certain embodiments, enable a user to interact with the computer system 300. In a further embodiment, the display adapter 322 may display a graphical user interface (GUI) associated with a software or web-based application on a display device 324, such as a monitor, display, or touch screen device of any kind.

The I/O adapter 310 may couple one or more storage devices 312, such as one or more of a hard drive, a solid state storage device, a flash drive, a compact disc (CD) drive, a floppy disk drive, and a tape drive, to the computer system 300. According to one embodiment, the data storage 312 may be a separate server coupled to the computer system 300 through a network connection to the I/O adapter 310. The communications adapter 314 may be adapted to couple the computer system 300 to the network 110, which may be one or more of a LAN, WAN, and/or the Internet. The communications adapter 314 also may be adapted to couple the computer system 300 to other networks such as a global positioning system (GPS) or a Bluetooth network. The user interface adapter 316 couples user input devices, such as a keyboard 320, a pointing device 318, and/or a touch screen (not shown) to the computer system 300. The keyboard 320 may be an on-screen keyboard displayed on a touch panel. Additional devices (not shown) such as a camera, microphone, video camera, accelerometer, compass, and or gyroscope may be coupled to the user interface adapter 316. The display adapter 322 may be driven by the CPU 302 to control the display on the display device 324. Any of the devices 302-322 may be physical and/or logical.

The applications of the present disclosure are not limited to the architecture of the computer system 300. Rather the computer system 300 is provided as an example of one type of computing device that may be adapted to perform the functions of a universal distributed computing nodes 101a-d. For example, any suitable processor-based device may be utilized including, without limitation, personal data assistants (PDAs), tablet computers, smartphones, computer game consoles, and multi-processor servers. Moreover, the systems of the present disclosure may be implemented on application specific integrated circuits (ASIC), very large scale integrated (VLSI) circuits, state machine digital logic-based circuitry, or other circuitry.

The embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules. As such, persons of ordinary skill in the art may utilize any number of suitable electronic devices and similar structures capable of executing a sequence of logical operations according to the described embodiments. For example, the computer system 300 may be virtualized for access by multiple users and/or applications.

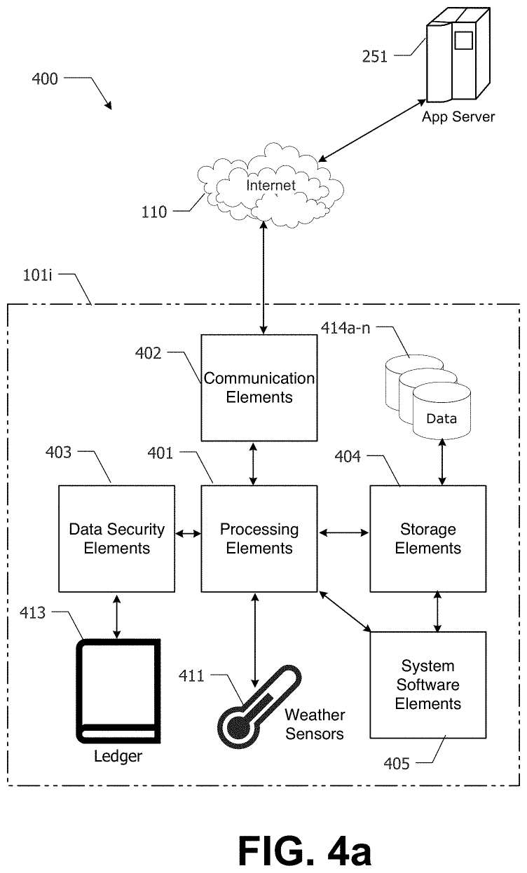

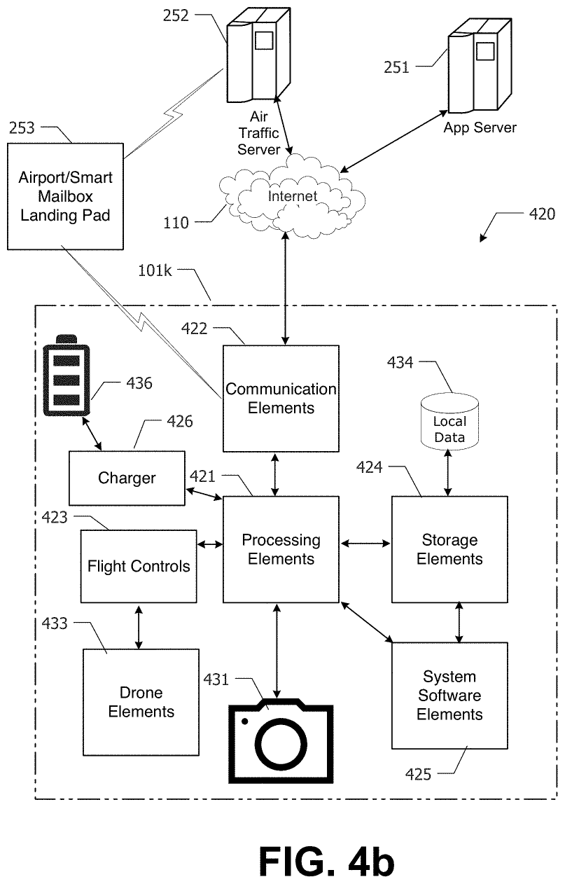

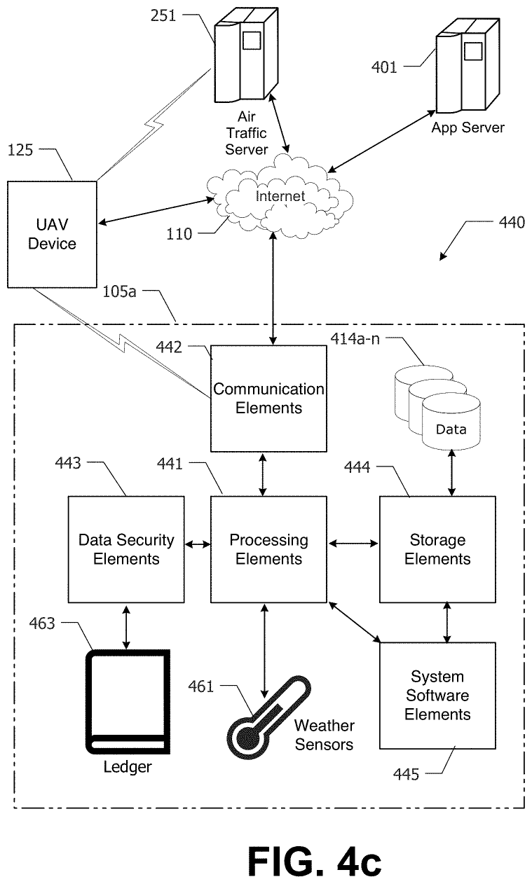

FIGS. 4a-c illustrate a set of hardware components of various embodiments of a universal computing node within a smart self-healing node centric blockchain mesh network according to the present invention. FIG. 4a shows a universal computing node within a smart self-healing node centric blockchain mesh network within a distributed computing device having a network of UAVs, rooftop UAV airports and landing pads, and remote UAV landing pads such as the Smart Rooftop Airport and Landing Pad™ and the Smart Mailbox Landing Pad™ disclosed in the commonly owned US Patent applications cited above. The set of hardware components comprises a processing element 401, a communications element 402, a data security element 403, a storage control element 404, system software elements 405, one or more sensors 411, a data ledger 413, and data storage device 414a-n.

The processing element 401 are digital computing components that perform processing operations within the computing node 101 including microprocessors and similar programmable devices. The processing elements 401 may be executed as a set of instructions executed by a general purpose computing device, a set of firmware performed within an embedded computing device, and a state machine based sequencer and command generated within digital logic components within discrete electronics and/or within a custom programmable logic device or VLSI integrated circuit that implement the functions of the software components.

The communications element 402 provides transceivers to send and receive digital data packets to other computing nodes and servers over various communications channels. The communications channels may provide communications over wide area networks such as the Internet 110, communications over local area networks that are both wired and wireless communication media, and communications over a point-to-point communications link with mobile computing nodes. The communications channels can be implemented using a wide area network (WAN), a virtual private network (VPN), metropolitan area networks (MANs), system area networks (SANs), a DOCSIS network, a fiber optics network (e.g., FTTH (fiber to the home) or FTTX (fiber to the x), or hybrid fiber-coaxial (HFC)), a digital subscriber line (DSL), a public switched data network (PSDN), a global Telex network, or a 2G, 3G, 4G or 5G network, for example. The communications channels can also be implemented using a fixed wireless connection that operates in accordance with, but is not limited to, 3rd Generation Partnership Project (3GPP) Long Term Evolution (LTE) or 5G protocols.

The wireless communications channels may provide a wireless connection in accordance with any IEEE 802.11 Wi-Fi protocols, Bluetooth protocols, Bluetooth Low Energy (BLE), or other short range protocols that operate in accordance with a wireless technology standard for exchanging data over short distances using any licensed or unlicensed band such as the citizens broadband radio service (CBRS) band, 2.4 GHz bands, 5 GHz bands, or 6 GHz bands as well as can be implemented using a wireless connection that operates in accordance with, but is not limited to, RF4CE protocol, ZigBee protocol, Z-Wave protocol, or IEEE 802.15.4 protocol.

The data security element 403 and the data ledger 413 are processing any data storage devices used to implement a blockchain data storage system including all of the processing steps and data storage to implement a blockchain ledger 115a for the self-healing blockchain-based data exchanges 121 within the computing nodes 105a. Additional details regarding the blockchain data storage system may be found in the “A Data Exchange Within a Smart Self-Healing Node Centric Blockchain Mesh Network” patent application cited above.

The storage control element 404 provides control and communications modules used to connect various data storage devices to the computing node 105a. These data storage devices may include magnetic hard drives (HD), solid state data devices (SSD), and similar memory components used for long term and/or semi-permanent data storage for the computing nodes. The storage control element 404 provides the electrical connections and signal generation needed to connect the storage devices to the processing elements 401 and related components of the computing node 105a.

The system software elements 405 correspond to one or more sets of software components that are contained within the computing node 105a. Examples of these sets of software components and their respective functions are disclosed in detail in reference to FIGS. 5a-c below.

The one or more sensors 411 correspond to local input devices 207b and local hardware 207a that provide data to the computing node 101 as disclosed above in reference to FIG. 2. For the examples herein used in a system of UAVs 125 and its supporting computing devices include these sensors generate images, video, and audio data from a camera device 207a that provide a real-time view of an area about the computing node 105a. These sensors 411 also may generate weather data that measure weather data including temperature, wind speed and direction, humidity, barometric pressure, and precipitation, among other data values.

The data storage device 414a-n provides local data storage within the computing node 101 and may include magnetic hard drives (HD), solid state data devices (SSD), and similar memory components used for long term and/or semi-permanent data storage for the computing nodes.

FIG. 4b shows a set of hardware components within a universal computing node within a smart self-healing node centric blockchain mesh network configured to act within a UAV to perform data communications and flight controls for the UAV as disclosed in the commonly owned US Patent applications cited above. The set of hardware components comprises a processing element 421, a communications element 422, a data security element 423, a storage control element 424, system software elements 425, image sensors 431, a data ledger 433, and data storage device 434. The functionality of the hardware components 531-545 of FIG. 4b perform the same functions as the corresponding hardware components disclosed above in reference to FIG. 4a.

FIG. 4c shows a set of hardware components within a universal computing node within a smart self-healing node centric blockchain mesh network configured to act as a remote UAV smart mailbox landing pad such as a smart mailbox landing Pad™ disclosed in the commonly owned US Patent applications cited above. The set of hardware components comprises a processing element 441, a communications element 442, a data security element 443, a storage control element 444, system software elements 445, weather sensors 461, a data ledger 463, and data storage device 464a-n. The functionality of the hardware components 551-565 of FIG. 4c perform the same functions as the corresponding hardware components disclosed above in reference to FIG. 4a.

FIGS. 5a-b illustrate a computing system of software components of various embodiments of a universal computing node within a smart self-healing node centric blockchain mesh network according to the present invention. FIG. 5a shows a set of software components 500 used within a universal computing node within a distributed computing device within a network of UAVs, rooftop UAV airports and landing pads, and remote UAV landing pads such as the Smart Rooftop Airport and Landing Pad™ and the Smart Mailbox Landing Pad™ disclosed in the commonly owned US Patent applications cited above. The set of software components comprises a node controller 501, a web interface 502, a wireless interface 503, a blockchain processor 504, a storage interface 505, an app loader/retriever 506, and a sensor interface 507.

The node controller 501 acts as a central overall controller for the set of software components 502-515. Commands from the applications are received and processed to determine actions to be taken, and then mobile app commands are passed to the other software components 502-515, as needed, to implement the actions to be taken. The node controller 501 also may receive and process data received from the web interface 502, the wireless interface 503, and the local hardware and local input devices for use in the applications running in the computing node 105a.

The web interface 502 permits the computing nodes 105a to communicate with remote computing devices such as application servers 103c, air traffic servers 103a, and UAVs 125. The web interface 502 performs the data formatting, computer-to-computer communications, encryption processing, and all similar operations needed by the computing node 101 to communicate with these remote systems and devices.

The wireless interface 503 also permits the computing nodes 105a to communicate with remote computing devices such as application servers 103c, air traffic servers 103a and UAVs 125 over a wireless communications channel. The wireless interface 503 is especially useful to permit a computing node 105a to communicate with a computing node within a UAV 125 while in flight. The wireless interface 503 performs all of the data formatting, computer-to-computer communications, encryption processing, and all similar operations needed by the computing node 105c to communicate with these remote systems and devices.

The blockchain processor 504 performs blockchain operations to maintain data within the blockchain ledger 413 used to provide security and data integrity for the data changes as disclosed in the “A Data Exchange Within a Smart Self-Healing Node Centric Blockchain Mesh Network” patent application cited above.

The storage interface 505 provides input and output processing to provide a node controller 501 and all other software components 502-515 with data needed to perform the functions implemented in the application running in the computing node 105a. This storage interface 505 maintains all data stored on the local storage devices 414a-n as well as stores, retrieves, and deletes the data stored within the local storage device 414a-n as needed.

The app loader/retriever 506 receives commands from the node controller 501 to locate and download one or more mobile applications from the application server 103c for use within the computing node 105a. The app loader/retriever 506 sends requests to the application server 103c, downloads applications from the application server 103c, stores the applications into the local storage devices 414a-n for later use, and retrieves the applications from the local storage devices 414a-n for execution within the computing node 105a when needed. The app loader/retriever 506 also may periodically check for updates to previously downloaded applications and download updates from the application server 103c to permit the computing node 105a to maintain a current version of the applications.

The sensor interface 507 provides input and output processing to receive input data from the local hardware 209 and local input devices 107a-n to provide a node controller 501 and all other software components 502-515 with data needed to perform the functions implemented in the application running in the computing node 105a.

FIG. 5b shows a set of software components within a universal computing node within a smart self-healing node centric blockchain mesh network within a UAV 125 to perform data communications and flight controls for the UAV as disclosed in the commonly owned US Patent application cited above according to the present invention. The set of software components 530 comprises a node controller 531, a web interface 532, a wireless interface 533, a blockchain processor 534, a storage interface 535, an app loader/retriever 536, and a sensor interface 537. The functionality of the software components 531-545 of FIG. 5b perform the same functions as the corresponding hardware components disclosed above in reference to FIG. 5a.

FIG. 5c shows a set of software components within a universal computing node within a smart self-healing node centric blockchain mesh network configured to act as a remote UAV smart mailbox landing pad such as a smart mailbox landing Pad™ disclosed in the commonly owned US Patent application cited above. The set of software components 550 comprises a node controller 551, a web interface 552, a wireless interface 553, a blockchain processor 554, a storage interface 555, an app loader/retriever 556, and a sensor interface 556. The functionality of the software components 551-565 of FIG. 5c perform the same functions as the corresponding hardware components disclosed above in reference to FIG. 5a.

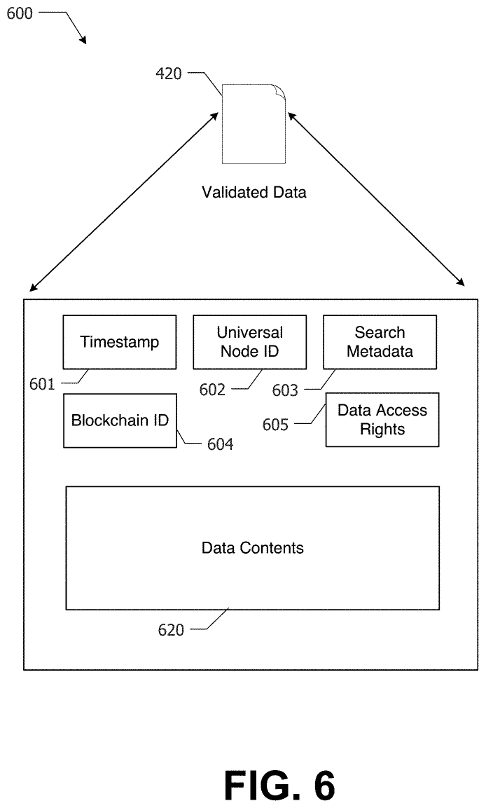

FIG. 6 illustrates a set of universal node software components that may be used as part of a system for providing a UAV-based inspection system within a smart self-healing node centric blockchain mesh network having blockchain processing according to the present invention. Validated data 420 is stored within the blockchain record 600 that comprises at least the following data fields: a timestamp field 601, a universal node ID field 602, a sensor metadata field 603, a blockchain address ID 604, a data access rights field 605, and a data contents field 620.

The timestamp field 601 contains time and date data corresponding to the date and time when data from the sensors 406 was captured. Using the example embodiment of a universal computing node 105a that collects weather data, the timestamp field 601 captures when the weather data was recorded. The timestamp data may be used to determine whether the weather data contained within the blockchain record 600 is too stale to be considered current weather condition measurements for use with UAVs currently airborne about this particular universal computing node 105a. This timestamp data also may be used when past conditions at a specified time are needed and are retrieved from the blockchain ledger 115i.

The universal node ID field 602 contains a unique identifier that corresponds to the universal computing node 105a that generated the data contained within the blockchain record 600. This unique identifier will identify the source operating the universal computing node 105a as well as its location.

The sensor metadata field 603 defines the contents of the blockchain record 600 in terms to be used when a search is performed for requested data. The universal computing node 105a is configured to specify relevant terms that will permit the record to be found when needed. For the embodiment that collects weather data, the month, day, and year of the data's collection, the location of the sensors when the data was collected, and the types of data contained therein typically is used for the contents of the sensor metadata field 603. This metadata may be configured when the universal computing node 105a is initialized. The metadata also may be updated periodically when other useful terms may be associated with the sensor data when it is being collected. For example, weather data collected as a named storm passing by the universal computing node 105a may be a useful metadata value which would allow users to search for all data associated with “Hurricane Amy” for data collected when this particular named hurricane was in the vicinity. This particular metadata term may then be removed from insertion into new blockchain records 600 once the hurricane has moved on.

The blockchain address ID 604 contains a unique address corresponding to the location of the blockchain record 600 within the blockchain ledger 115i. All blockchain ledgers identify their location within the ledger permitting specific data records be retrieved from any universal computing node maintaining a copy of this particular ledger.

The data access rights field 605 contains a default set of digital data rights that may be obtained for the data within a particular blockchain record 600. As disclosed in detail in reference to FIG. 7 below, data within the self-healing blockchain-based data exchange 121 may be acquired by a user in one or more of a defined set of type of digital rights available for purchase. The owner of the collected data may specify how the data may be acquired and the possible types of rights are identified in the data access rights field 605. For example, data within a data record 600 may be acquired for use for a limited period of time or may be acquired with a specific set of permissible uses. These access rights are set by the data owner. The type of access rights may change over time as the nature of the data changes. For weather data, permissible uses of data that is considered current may be different from permissible uses once the weather data is considered historical. The price associated with each permissible use and type of access rights granted may depend upon the nature of the data at the time the data is used as well as when it is acquired.

The data contents field 620 contains the data from the sensors 406. The particular sensors used, their serial numbers, and other relevant information associated with the data is contained in the data contents field. Of course, the contents of the data may vary depending upon the sensors, the associated data scales of the data, any language of users of the data, and many other values contained in this data field. Alternatively, additional fields also may be included within the blockchain data record 600. For example, an additional field that states whether temperature data is measured in Fahrenheit or Celsius data. Similarly windspeeds may be measured in miles per hour or meters per second depending upon the sensor and the data usage.

The embodiments described herein with respect to all of the components of the universal computing node 105a may be implemented as logical operations performed by a computer. The logical operations of these various embodiments of the present invention are implemented (1) as a sequence of computer implemented steps or program modules running on a computing system and/or (2) as interconnected machine modules or hardware logic within the computing system.

Accordingly, the logical operations making up the embodiments of the invention described herein can be variously referred to as operations, steps, or modules. As such, persons of ordinary skill in the art may utilize any number of suitable electronic devices and similar structures capable of executing a sequence of logical operations according to the described embodiments. This characterization of the processing components also applied to the processing components within the data exchange and the universal computing nodes within the smart self-healing node centric blockchain mesh network as disclosed in the related US patent applications referenced above.

Additionally, the logical operations making up the embodiments of the present technology described herein can be variously referred to as operations, steps or modules. In order to provide functionality according to some other embodiments, such steps, processes or methods may be performed in different orders than those described and illustrated in the drawings and one or more steps, processes or methods may be omitted. These modules may be implemented as software executing on a general purpose computing device, firmware executing with an embedded processing device within a component of a computing system, and a state machine-based electronic sequencer that generates a sequence of electrical signals within discrete electronics and/or within a custom programmable logic device or VLSI integrated device that cause the sequence of operations described herein being equivalent. The implementation is a matter of choice dependent on the performance requirements of the computing system implementing the invention.

If implemented in firmware and/or software, the functions described above may be stored as one or more instructions or codes on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc include compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. A system for providing a universal computing node within a smart self-healing node centric blockchain mesh network, the universal computing node comprises:
a set of programmable processing components for executing a set of software components within the universal computing node;
a self-healing blockchain data exchange for securely storing data available for retrieval, the data retrieved from the self-healing blockchain data exchange provides a chain of custody providing all storage locations since generation and provides digital access rights associated with permissible uses for the retrieved data; and
one or more external sensors for generating data to be stored within the self-healing blockchain data exchange.

2. The universal computing node according to claim 1, wherein the universal computing node further comprises:
a communications interface for communicatively coupling the universal computing node to one or more additional universal computing nodes and one or more servers connected to the smart self-healing node centric blockchain mesh network;
a power source for providing operating energy when operating the universal computing node; and
local data storage for retaining data within the universal computing nodes.

3. The universal computing node according to claim 1, the self-healing blockchain data exchange comprises:
a blockchain ledger containing a plurality of blockchain data records; and
a blockchain processor for generating each of the blockchain data records containing data stored within the self-healing blockchain data exchange.

4. The universal computing node according to claim 3, each of the blockchain data records comprises:
a time stamp data field for storing time data associated with the blockchain data record is added into the self-healing blockchain data exchange;
a universal node ID field for storing a unique identifier for the universal computing node generating the data added into the self-healing blockchain data exchange;
a blockchain ID for storing a unique identifier for the blockchain data record added into the self-healing blockchain data exchange;
a data access right field for identifying rights available; and
a data contents field for storing the data being stored within the blockchain data records.

5. The universal computing node according to claim 3, wherein the universal computing node software components comprise:
a node controller for coordinating the interaction and processing the set of software components when generating, storing and retrieving blockchain data records;
a web interface for transmitting and receiving data between the universal computing node and one or more additional universal computing nodes and one or more servers connected to the smart self-healing node centric blockchain mesh network;
the blockchain processor for generating blockchain data records to be stored within the blockchain ledger; and
a sensor interface for receiving data to be stored within one or more blockchain data records.

6. The universal computing node according to claim 5, wherein the set of node software components further comprises:
a wireless interface for transmitting and receiving data between the universal computing node and one or more additional universal computing nodes and one or more servers connected to the smart self-healing node centric blockchain mesh network over a wireless data channel;
a storage interface communicatively connecting the set of software components within the universal computing node to semi-permanent data storage devices within the universal computing node; and
an app loader/retriever for retrieving programmable software components from a remote application server on the smart self-healing node centric blockchain mesh network to provide the universal computing node with functionality provided by the retrieved programmable software components.
